(19) United States
(12) Patent Application Publication
(10) Pub. No.: US 2003/0105406 A1
(43) Pub. Date: Jun. 5, 2003

(54) Multi-parameter acquisition of ECG and related physiologic data employing conventional ECG lead conductors

(76) Inventors: Peter M. Galen, McMinnville, OR (US); Martin Baumer, Carlton, OR (US); Steven A. Mahoney, McMinnville, OR (US)

Correspondence Address: KOLISCH HARTWELL, P.C., 520 S.W. YAMHILL STREET, SUITE 200, PORTLAND, OR, 97204, US

(21) Appl. No.: 10/175,545

(22) Filed: Jun. 18, 2002

Related U.S. Application Data
(60) Provisional application No. 60/299,265, filed on Jun. 18, 2001.
(60) Provisional application No. 60/299,161, filed on Jun. 18, 2001.
(60) Provisional application No. 60/299,264, filed on Jun. 18, 2001.
(60) Provisional application No. 60/299,580, filed on Jun. 19, 2001.
(60) Provisional application No. 60/299,577, filed on Jun. 19, 2001.
(60) Provisional application No. 60/299,550, filed on Jun. 19, 2001.
(60) Provisional application No. 60/299,551, filed on Jun. 19, 2001.
(60) Provisional application No. 60/299,522, filed on Jun. 20, 2001.

(51) Int. Cl. H01R 29/00

(52) U.S. Cl. 600/509; 307/326; 439/188

(57) ABSTRACT

A system involving disconnectably connectable sensor and adaptor units which can be employed to allow for the collection and communication, along with ECG data, of other physiologic parameter data whose condition is helpful in a evaluating communicative ECG data. Connection between the adaptor and sensor units of the invention effects the establishment of circuitry which allows (a) for the use of conventional ECG lead conductors alone to be responsible for carrying all categories of data, (b) for providing fail-safe communication of ECG data, and (c) for defining through different interfacial connective structures the actual characters of other-parameter data that will be communicated outwardly from a subject.

### CROSS-REFERENCE TO RELATED APPLICATIONS

This application claims the priority under 35 U.S.C. §119 and applicable foreign and international law of the following U.S. Provisional Patent Applications: Serial Nos. 60/299,265 filed Jun. 18, 2001, 60/299,161 filed Jun. 18, 2001, 60/299,264 filed Jun. 18, 2001, Serial No. 60/299,580 filed Jun. 19, 2001, Serial No. 60/299,577 filed Jun. 19, 2001, Serial No. 60/299,550 filed Jun. 19, 2001, Serial No. 60/299,551 filed Jun. 19, 2001, and Serial No. 60/299,522 filed Jun. 19, 2001, all of which are hereby incorporated by reference in their entireties for all purposes.

### BACKGROUND AND SUMMARY OF THE INVENTION

This invention relates to a system for acquiring multi-parameter physiologic data from a patient. According to the invention, plural categories of data, one of which is conventional ECG data and the other(s) of which take the form(s) of other-physiologic-parameter data, such as sound and spatial orientation, are collected contemporaneously from a common or nearly common anatomical site. Collection is accomplished, according to a preferred form of the invention, utilizing a disconnectable unitary sensor component which is designed with appropriate transducers that are configured to accomplish such multi-parameter collection.

Though it may be employed differently, the proposed sensor, in its preferred form, is patient-specific and discardable, and is removably and operatively connectable effectively to the end of an otherwise conventional ECG lead-conductor set. If the sensor is not to be employed in a patient-specific manner, it can be treated as a couplable/uncouplable reusable device. The sensor is constructed with appropriate data-collection transducer structures so that it can be employed essentially at a single, localized anatomical site for accomplishing the desired multi-parameter data collection.

The sensor which is employed according to this invention is one which connects disconnectively to an associated, special adaptor, where the latter is a structure that is directly connected to conductors in a set of conventional ECG lead conductors. One of the two disconnectably connectable units, just referred to as a sensor and an adaptor, may include a power source, such as a battery, which is employed to furnish power to circuitry which is brought into being by the act of connecting the adaptor and sensor so as to provide electrical power to that portion of componentry in the adaptor and sensor which is responsible for collecting and transmitting what is referred to above as other-parameter data.

Connection between the adaptor and the sensor accomplishes a number of advantageous conditions that are relevant to the contributions to the art made by this invention. For example, the act of connection between these two units establishes a circuit path which enables both traditional ECG data, and one or more categories of other-parameter data, to be communicated to the outside world, so-to-speak, utilizing only one or more conductor(s) that are present in a standard set of ECG lead conductors. No additional communication or signal-transmission line is required. Further, connection between these two units is such that the connection closes a circuit with respect to an internal power source which may be present, as just mentioned above. Additionally, and according to one embodiment of the invention, residing at what can be thought of as the connection interface between the adaptor and sensor units is connector structure which can be arranged selectively to communicate with a selected one or ones but not all of the so-called other-parameter data. With this possibility provided, multi-parameter-capable units, that is, internally capable units, can readily be provided just for selected areas of operation. This leads to economies in manufacture and inventory control. Still a further unique feature of this invention is that, in a circumstance where there is indeed a power source involved in one of the two units, such as the battery just mentioned above, if, during operation of the system employing the invention, there is a power failure involving the battery, such a power failure has no affect whatsoever on the ability of the system, and the componentry proposed by the present invention, to continue transmitting ECG data. This is an important fail-safe feature of the invention.

These and other embodiments of the invention which are more fully described below offer not only the features and advantages just mentioned above, but others that will become apparent upon a reading of the description which now follows in conjunction with the accompanying drawings.

### BRIEF DESCRIPTION OF THE DRAWINGS

FIG. 1 is a block/schematic diagram of a system employing a two-part (adaptor, sensor) arrangement constructed in accordance with the present invention.

FIG. 2 presents a circuit diagram of one form of circuitry which is employed in the adaptor and sensor components of the present invention, illustrated in this figure in a connected condition, and designed to communicate, outwardly from a subject, ECG data and sound data employing conventional conductors in a set of traditional ECG lead conductors.

FIG. 3 is similar to FIG. 2, except that here what is shown is a modified form of the invention wherein the particular form of connective interface structure which resides between the connected adaptor and sensor has been selectively designed to communicate ECG data and one only of two other categories of physiologic data (here sound data) regarding which the sensor unit of the invention is capable of capturing. Very specifically in FIG. 3 a sensor unit is illustrated which is capable of capturing, in addition to ECG data, sound data and spatial orientation data.

FIG. 4 is directly related to FIG. 3 and illustrates, in simplified block and schematic form, the specific interface structure which has been selected to produce the performance just described for FIG. 3.

FIG. 5 is similar to FIGS. 2 and 3, generally, but here shows a modification of the invention which, like that pictured in FIGS. 3 and 4, has been selectively organized through the interface connector structure between the adaptor and sensor unit to communicate, along with ECG data, another single category of plural-available, other-parameter data. In FIG. 5, the sensor unit is identical in construction to the sensor unit pictured in FIGS. 3 and 4. However, the adaptor section, pictured toward the right sides of FIGS. 5 and 6, has here been configured with structure that selectively allows communication only for ECG and spatial-orientation data, though the sensor unit is fully capable of transmitting also sound data.

### DETAILED DESCRIPTION, AND BEST MODE FOR CARRYING OUT, THE INVENTION

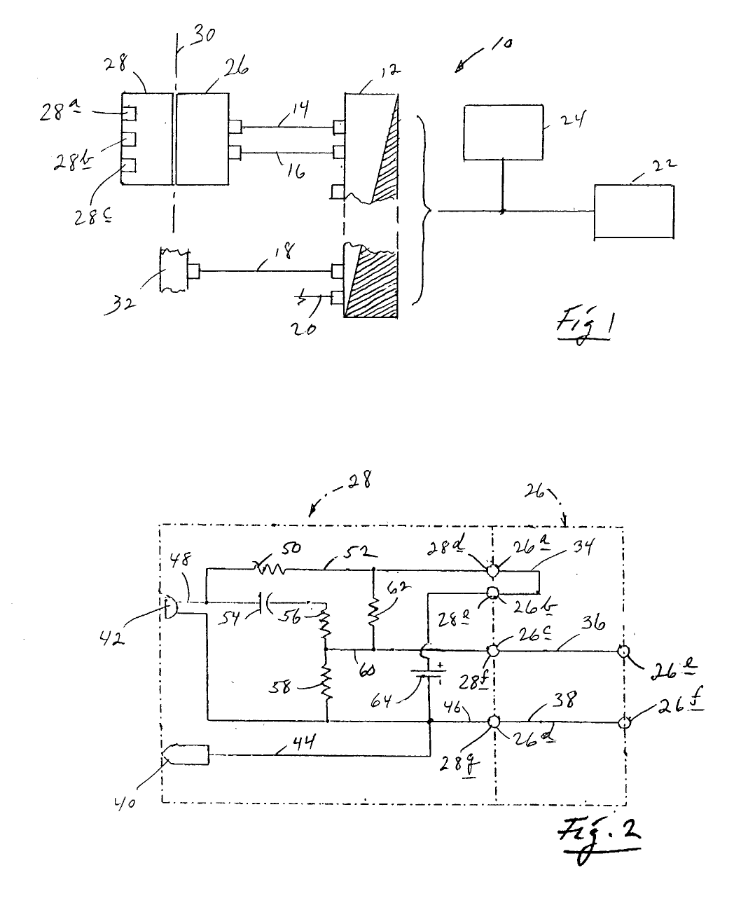

Turning attention now to the drawings, and referring first of all to FIG. 1, here illustrated generally at 10 is a system employing the present invention to gather, in addition to conventional ECG data, one or more other categories of data, such as sound data and spatial-orientation data, helpful in examining the condition and functioning of subject's heart. Centered in FIG. 1 as a fragmented block 12 is a set of conventional ECG lead conductors, with this block being shaded diagonally to highlight the fact that various different conventional sets of ECG lead conductors can be employed. The shaded area, for example, represents one style of a conventional set of ECG lead conductors, and the unshaded portion of block 12 represents another conventionally-available set. On the left side of this block in FIG. 1 are shown some small rectangles which represent points of connection for outwardly extending conductor leads, four of which are shown at 14, 16, 18 and 20 in FIG. 1.

Illustrated to the right of FIG. 1 as being connected appropriately to what can be thought of as the output side of block 12 are a conventional cardiograph machine 22, and, just for illustration purposes, a data interpretation unit 24. The exact constructions of these two structures (22, 24) form no part of the present invention, and thus are neither illustrated nor discussed in any detail herein.

As shown in FIG. 1, conductor leads 14, 16 extend from block 12 to a block 26 which is one of the two principal component elements proposed by the present invention. Each of these elements is referred to as a part herein, and the specific element represented by block 26 is referred to both as an adaptor, and as a first part.

Disconnectably connected to adaptor 26 is a sensor shown in block form at 28. Block 28 is the other unit proposed by the present invention that is disconnectably connectable to adaptor 26, thus to be treatable as a patient-specific unit. Adaptor 26 and sensor 28 are coupled through appropriate physical interface conductor structure (not specifically shown in FIG. 1) with connection between these two units effectively residing in a region of joinder which is represented by dash-dot line 30 in FIG. 1.

Included within sensor 28 in the illustration now being given are three transducers 28a, 28b, 28c which are employed to gather different kinds of ECG-relevant physiologic data in accordance with practice of the invention. Transducer 28a is designed to collect sound data, transducer 28b conventional ECG data, and transducer 28c spatial-orientation data. All of such data, in accordance with the present invention, is communicated outwardly from the connected adaptor and sensor utilizing only conventional ECG lead conductors, such conductors 14, 16 mentioned above.

Lead conductor 18 is shown connected to a fragmentary illustration at 32 which is intended to represent the right leg of a subject. This connection is most frequently employed in the gathering of ECG data to act as a reference point electrically with regard to the collection of ECG data. It should be noted, and it is known, that the so-called right-leg connection as a reference connection could be replaced with another type of connection. The specific site for such a reference connection herein is not part of the present invention.

The other leads, only one of which is shown at 20, that form part of lead-conductors 12 extend appropriately for connection to other points on the anatomy of a subject where data is being collected.

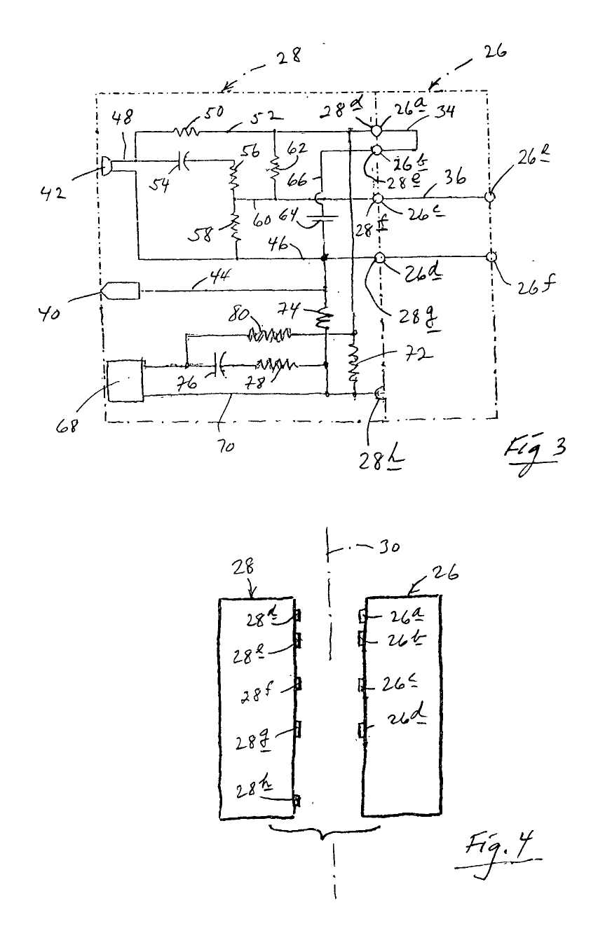

Referring now to FIG. 2, in this figure one sees details of internal construction, circuit construction, which form one embodiment arrangement for adaptor 26 and sensor 28. The circuitry which is illustrated in each of these two parts in FIG. 2 is referred to circuit substructure, and when these two circuit substructures are connected as shown in FIG. 2, they are collectively referred to as a cooperative co-action circuit.

Included within adaptor 26 are four input terminals which are designated 26a, 26b, 26c, 26d. Also included are two output terminals which are shown at 26e and 26f. Extending between terminals 26a, 26b is a conductor 34, extending between terminals 26c, 26e is a conductor 36; and extending between terminals 26d, 26f is conductor 38.

In the specific embodiment of sensor 28 pictured in FIG. 2, as distinguished from what is shown for this unit in FIG. 1, here there are shown only two data transducers. These include an ECG transducer 40, and a phono, or sound, transducer 42. On what can be thought of as the output side of sensor 28 there are shown four output terminals 28d, 28e, 28f and 28g.

ECG transducer 40 is connected through conductors 44, 46 to output terminal 28g.

Transducer 42, which might typically be a microphone, is connected directly to conductor 46, and through a conductor 48, a resistor 50 and a conductor 52 directly to output terminal 26d. Conductor 46 connects with the left side of a capacitor 54, the right side of which is connected through a resistive voltage divider including resistors 56, 58 to previously-mentioned conductor 46. The point of connection between resistors 56, 58 is connected through a conductor 60 which extends directly to output terminal 28f.

Extending between and connecting conductors 52, 60 is a resistor 62. A battery, also referred to herein as a power source, shown at 64 extends between and is connected to previously-mentioned conductor 46, and to output terminal 28e. As can be seen, conductor 60 extends to and connects directly with output terminal 28f.

It will clear to those skilled in the art looking at FIG. 2 how what is shown therein operates. ECG signals picked up by transducer 40 are fed directly to output terminal 28g, and thence through adaptor input terminal 26d, conductor 38 and adaptor output terminal 26f to an appropriate remote site for the collection of ECG data, as is generally pictured in FIG. 1. Signals appearing at output terminal 26f are referenced to the right leg connection mentioned earlier.

Sound signals picked up by transducer 42 are supplied ultimately outwardly through adaptor output terminal 26e to an appropriate external structure designed to collect and manage this data. Transducers 40, 42 are physically close to one another, and thus can be thought of as collecting their respective different categories of data at, generally speaking, a common anatomical site on a subject's anatomy. One will notice that, upon disconnection of adaptor 26 and sensor 28, the battery power supply circuit which operates the circuit structure involved with phono data, and which relies for continuity upon the connection established as seen in FIG. 2 via conductor 34, is broken. But this condition has no effect whatsoever upon the operation of ECG transducer 40. Thus, this structure just described can be seen to meet the behavior referred to above as fail-safe operation with respect to the integrity of the supply of ECG data.

The connection established between parts 26, 28, as pictured in FIG. 2, establishes an operative circuit connection which allows for the collection and transfer of both categories of data respecting which sensor 28 is capable of gathering. All such data is carried via the two conventional ECG lead conductors that are connected to output terminals 26e, 26f in the adaptor (see conductors 14, 16 in FIG. 1).

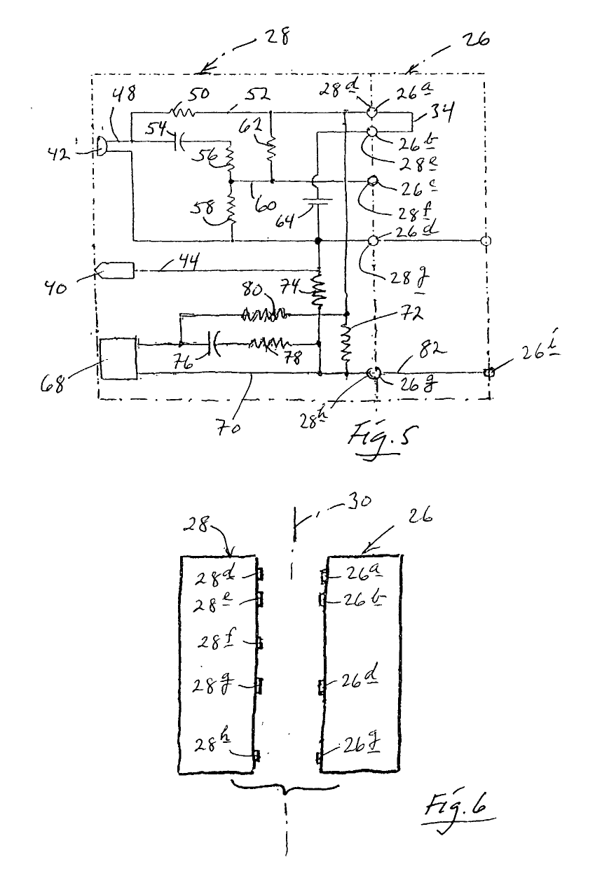

Shifting attention now to FIG. 3, here there is shown a modified form of adaptor and sensor structure(s) which relates to one feature of a modified form of the invention which allows for selective operation of the interconnected sensor and adaptor whereby only one of two or more categories of other-parameter data (that is, other than ECG data) can be designedly outwardly communicated from the adaptor/sensor assembly. Components and connections that are pictured in FIG. 3 that are essentially the same as components and connections that have just been described above with respect to FIG. 2 bear the same reference numerals, and are not further discussed in any particular detail. The internal structure of adaptor 26 is the same as that which is shown in FIG. 2. However, the internal structure of sensor 28 is different, chiefly by the addition to this sensor of a spatial-orientation transducer which is shown at 68. One of the output terminals in transducer 68 is connected through a conductor 70 directly to a new output terminal in sensor 28 which is shown at 28h. A resistor 72 interconnects conductors 70, 52 as shown, and a resistor 74 interconnects conductors 70, 46 as shown. The other output terminal in transducer 68 is connected through a capacitor 76 and a resistor 78 to the location where resistor 74 and conductor 70 interconnect. A resistor 80 also extends from this transducer output terminal, connecting it to the region where the upper end of resistor 72 connects with conductor 52. Looking now at FIG. 4 along with FIG. 3 which shows, in block schematic form, the region of the interfacial connection between adaptor 26 and 28, this view, along with what is shown in FIG. 3, helps to describe an important feature of the invention. Looking at these two figures together, one will clearly observe that no connection is provided through adaptor 26 for output terminal 28h in the sensor. A consequence of this is that no spatial-orientation parameter data is communicated outwardly from the coupled connection of adaptor 26 and sensor 28. This condition of selection allows the construction, as illustrated herein, of terminals in adaptor 26 effectively to control the nature of other-parameter output data which becomes outwardly communicated data.

FIGS. 5 and 6 give a different illustration of the very same feature of the invention. Here, the internal circuitry provided in sensor 28 is essentially identical to that which is shown in the sensor structure pictured in FIG. 3. However, the internal construction of adaptor 26 is quite different. Very specifically, in this embodiment of the invention, no connection for the output of data is provided for sensor output terminal 28f. There is, however, an output connection which is provided for previously-mentioned output terminal 28h.

Very specifically, in this embodiment of the invention, adaptor 26 is provided with an input terminal 26g which connects with output terminal 28h, and there is a conductor 82 which extends in the adaptor between input terminal 26g and a new output terminal 26i provided in the adaptor.

FIG. 6 illustrates in principally the same manner employed in FIG. 4 the thus different structural character of the interfacial terminals/connectors which establish communication between adaptor 26 and sensor 28 when the two units are brought together. In this illustration, no phono output information is furnished, but ECG data and spatial-orientation data are communicated. It will thus be seen how the interfacial connector structure can be employed to effect selective operation of less than all output data derivable and collectable by the other-parameter data transducers provided in sensor 28.

It should be very apparent that this phenomena of selectivity can be afforded in different embodiments which deal with different kinds of parameter data, and even a greater number of collection transducers in different categories may be provided in sensor 28.

It should thus be very apparent how the features and advantages that were discussed generally above as being offered and provided by the present invention are indeed made available. Several modifications have been illustrated herein and it is believed that the illustrations and discussions of these modifications set the stage clearly for an understanding in the minds of those skilled in the art how various changes and modifications can be made to suit different applications, all of which will come in the scope of the present invention.

While the invention has been disclosed in a particular setting, and in particular forms herein, the specific embodiments disclosed, illustrated and described herein are not to be considered in a limiting sense. Numerous variations, some of which have been discussed, are possible. Applicants regard the subject matter of their invention to include all novel and non-obvious combinations and subcombinations of the various elements, features, functions and/or properties disclosed herein. No single feature, function, element or property of the disclosed embodiments is essential. The following claims define certain combinations and subcombinations which are regarded as useful, novel and non-obvious. Other such combinations and subcombinations of features, functions, elements and/or properties may be claimed through amendment of the present claims or through presentation of new claims in this or in a related application. Such amended and/or new claims, whether they are broader, narrower or equal in scope to the originally presented claims, are also regarded as included within the subject matter of applicants' invention.

We claim:

1. Two-part apparatus for operative connection to the distal end of a set of conventional ECG lead conductors for collecting from a person, and for transferring to a region outside of that person in a manner which enables such transferring to take place solely via conductors which form part of such a lead conductor set, plural-parameter physiologic (PPP) data, including ECG data, said apparatus comprising
a first part including circuit substructure which is directly and operatively connectable to one or more conductors in such a lead-conductor set,
a second part which is detachably connectable to said first part, and which includes circuit substructure that is detachably connectable to the circuit substructure in said first part, and
person-proximity, plural-parameter, data-gathering sensor (PPP) structure carried on said second part and operatively connected to the circuit substructure in said second part,
attachment of said first and second parts producing operative joinder of said two circuit substructures into a cooperative co-action circuit which enables the transfer of gathered PPP data from said sensor structure to one or more conductors in such a lead-conductor set.

2. The apparatus of claim 1, wherein said sensor structure is designed to be capable of gathering, in addition to ECG data, at least two categories of other-parameter physiologic data, said first and second parts each includes an interface connector structure which connects with the interface connector structure associated with the other part when the two parts are connected, and these interconnect structures are configured in such a manner that other-parameter information which is communicated to the region of joinder between the two parts from the second part is selectively different from the related information which is received by the first part, and specifically in such a fashion that less than all of the other parameter-data made available by the second part is communicated through and by said first part.

3. The apparatus of claim 2, wherein the difference which exists between communicated and received other-parameter data with regard to communication between said first and second parts results from the fact that the physical structures of the two interface structures differ.

4. The apparatus of claim 1 which further includes power-source structure nominally disposed within one of said two parts, which power-source structure is inactive when said first and second parts are detached, and is active when said first and said parts are attached, to supply operational electrical power which flows in both of said circuit substructures.

5. The apparatus of claim 4, wherein said circuit substructures and said power-source structure are constructed in such a manner that when the first and second parts are attached, and the circuit substructures are joined, the active/inactive state of the power-source structure is irrelevant to the delivery of ECG data through the two parts.
